(19) United States
(12) Patent Application Publication
(10) Pub. No.: US 2013/0010483 A1
(43) Pub. Date: Jan. 10, 2013

(54) AUTOMOTIVE HEADLAMP CONTROL DEVICE AND METHOD

(75) Inventor: CHI-SHENG GE, Tu-Cheng (TW)

(73) Assignee: HON HAI PRECISION INDUSTRY CO., LTD., Tu-Cheng (TW)

(21) Appl. No.: 13/211,335

(22) Filed: Aug. 17, 2011

(30) Foreign Application Priority Data
Jul. 8, 2011 (TW) 100124354

(51) Int. Cl. G01B 21/22

(52) U.S. Cl. 362/460

(57) ABSTRACT

An automotive headlamp control device capable of communicating with a vehicle to adjust aiming of headlamps of the vehicle includes a detecting module, a processing module, and a communication module. The detecting module detects any changes in angle of the vehicle in real time. The processing module obtains angle changes from the detecting module, determines whether adjustment of the aiming of the headlamps being needed, generates a control signal, when an adjustment being needed, according to predetermined adjustments associated with different angle changes and being stored in the processing module , to the vehicle to control the vehicle to adjust the aiming of the headlamps accordingly, and transmits the control signal to the vehicle through the communication module.

### BACKGROUND

1. Technical Field

The present disclosure relates to safety control devices and, particularly, to an automotive headlamp control device and a headlamp control method.

2. Description of Related Art

Some vehicles can automatically adjust aiming of their headlamps according to road features such as for steep grades and sharp turns. For example, some vehicles use a vehicle navigation system such as a global position system (GPS) to obtain road features, and determine where, during travel, to adjust aiming of the headlamps. However, such navigation systems rely on long distance communication with satellites or other means to navigation, which can experience interference and so cannot be relied on at all times.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an automotive headlamp control device in accordance with an exemplary embodiment.

FIG. 2 is a flowchart of an automotive headlamp control method in accordance with an exemplary embodiment.

### DETAILED DESCRIPTION

Embodiments of the present disclosure will now be described in detail, with reference to the accompanying drawings.

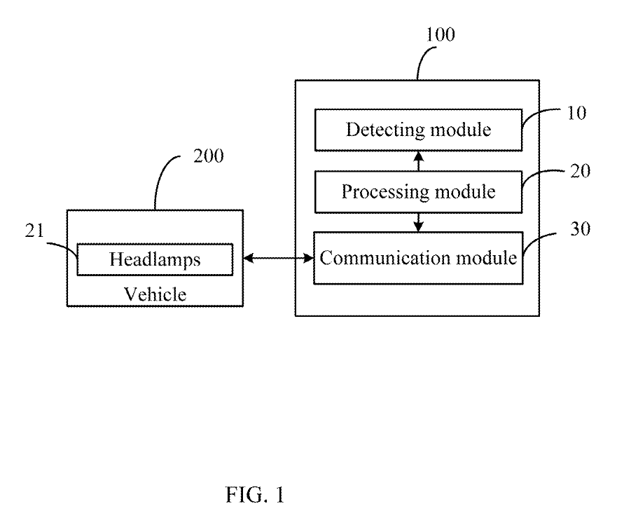

Referring to FIG. 1, an embodiment of an automotive headlamp control device 100 is illustrated. The device 100 may be a portable device, for example a mobile phone. In use, the device 100 may be mounted in a vehicle 200, such as a car or a bus. In this embodiment, the vehicle 200 is a car. Aiming of headlamps 21 of the car 200 can be adjusted by the car 200 according to communication from the device 100 by wired or wireless means. The device 100 detects a change in angle of the car 200 as would be caused by inclinations and turns in the path followed by the car during traveling, and generates a control signal according to the change, and transmits the control signal to the car 200 to control the car 200 to adjust aiming of the headlamps 21 to provide safer illumination of the roadway ahead without interfering with driver vision of oncoming traffic.

The device 100 includes a detecting module 10, a processing module 20, and a communication module 30. The communication module 30 may be hardwired to the car 200, by a cable of the device 100 being plugged into a connector of the car 200, or in wireless communication with the car 200 by the use of known technology such as BLUETOOTH.

When the processing module 20 receives a signal indicating that the headlamps 21 are on, the processing module 20 controls the detecting module 10 to detect any changes in angle of the car 200 in real time. In this embodiment, the detecting module 10 employs a gyroscope to detect angle changes.

The processing module 20 obtains angle changes from the detecting module 10 and determines whether adjustment of the aiming of the headlamps 21 is needed. The processing module 20 further generates and transmits a control signal, when an adjustment is needed, according to predetermined adjustments associated with different angle changes and stored in the processing module 20, to the car 200 to control the car 200 to adjust the aiming of the headlamps 21 accordingly.

For better understanding, an example is given to illustrate the present disclosure. In this example, when the car 200 is traveling on road with a change in grade, for example up 15 degrees, the detecting module 10 notifies the processing module 20, and the processing module 20 then generates and transmits a control signal to the car 200 to control the car 200 to adjust aiming of the headlamps 21 a predetermined amount associated with such angle change. Therefore, light beams of the headlamps 21 can illuminate movement direction of the car 200.

In an alternative embodiment, the device 100 may be a built-in part of the car 200.

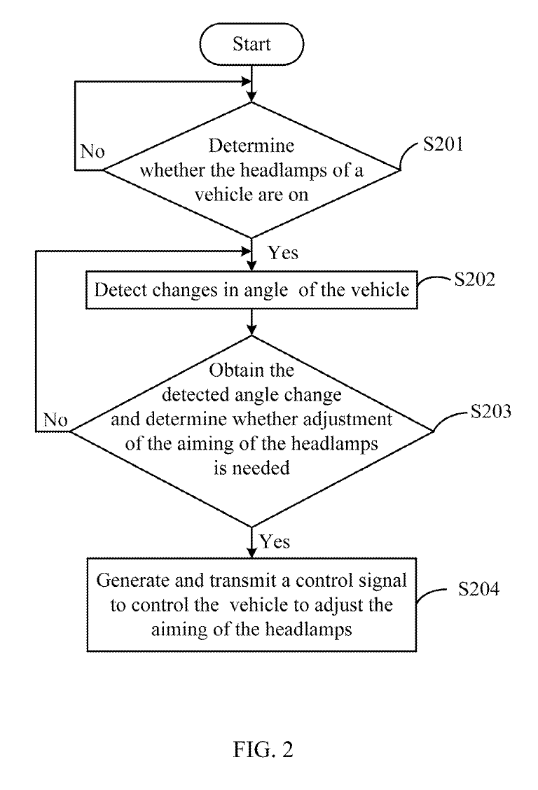

FIG. 2 is a flowchart of an automotive headlamp control method in accordance with an exemplary embodiment.

In step S201, the processing module 20 determines whether the headlamps 21 of the car 200 are on by determining whether receiving a signal indicating that the headlamps 21 are on from the car 200. If yes, the procedure goes to step S202; otherwise, the processing module 20 continues to execute the step S201.

In step S202, the detecting module 10 detects any changes in angle of the car 200 in real time.

In step S203, the processing module 20 obtains the detected angle change from the detecting module 10 and determines whether adjustment of the aiming of the headlamps 21 is needed, if it is, the procedure goes up to step S204, otherwise, the procedure goes back to step S202.

In step S204, the processing module 20 generates and transmits a control signal according to predetermined adjustments associated with different angle changes and stored in the processing module 20, to the car 200 to control the car 200 to adjust the aiming of the headlamps 21 accordingly.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An automotive headlamp control device capable of communicating with a vehicle to adjust aiming of headlamps of the vehicle, comprising:
a detecting module to detect an angle change of the vehicle in real time;
a communication module; and
a processing module to obtain the angle change from the detecting module, determine whether adjustment of the aiming of the headlamps is needed, when an adjustment being needed, generate a control signal, according to predetermined adjustments associated with the angle change, and communicate the control signal to the vehicle via the communication module to control the vehicle to adjust the aiming of the headlamps accordingly.

2. The automotive headlamp control device as described in claim 1, wherein the processing module controls the detecting module to detect a change in angle of the vehicle when receiving a signal indicating that the headlamps are on from the vehicle.

3. The automotive headlamp control device as described in claim 1, wherein the detecting module employs a gyroscope to detect the angle change of the vehicle.

4. The automotive headlamp control device as described in claim 1, wherein the communication module is wired to the vehicle by a cable plugged into a connector of the vehicle.

5. The automotive headlamp control device as described in claim 1, wherein the communication module communicates with the vehicle by wireless means.

6. The automotive headlamp control device as described in claim 1, wherein the automotive headlamp control device is a mobile phone.

7. An automotive headlamp control method applied in an automotive headlamp control device, the automotive headlamp control device capable of communicating with a vehicle to adjust aiming of headlamps of the vehicle, the method comprising:
detecting an angle change of the vehicle;
obtaining the detected angle change and determining whether adjustment of the aiming of the headlamps is needed;
generating a control signal according to predetermined adjustments associated with different angle changes;. transmitting the control signal to the vehicle to control the vehicle to adjust the aiming of the headlamps accordingly.

8. The automotive headlamp control method as described in claim 7, wherein before the step of “detecting an angle change of the vehicle”, the method further comprises:
determining whether the headlamps of the vehicle are on, when receiving a signal indicating that the headlamps are on from the vehicle, detecting the angle change of the vehicle.
